(19) United States
(12) Patent Application Publication
(10) Pub. No.: US 2007/0021278 A1
(43) Pub. Date: Jan. 25, 2007

(54) Load controller of magnetic brake for exercise machine

(75) Inventors: Francis Chung Hwa Pan, Taichung City (TW); Pao-Chuan Wang, Taichung County (TW)

Correspondence Address: BIRCH STEWART KOLASCH & BIRCH, PO BOX 747, FALLS CHURCH, VA, 22040-0747, US

(73) Assignee: Forhouse Corporation

(21) Appl. No.: 11/183,945

(22) Filed: Jul. 19, 2005

(51) Int. Cl. A63B 22/06; B60L 7/00

(52) U.S. Cl. 482/63; 188/161

(57) ABSTRACT

A load controller, which is mounted on a flywheel of an exercise machine, includes a base mounted on the flywheel. A rotator is pivoted on the base for rotation, on which connecting portions are provided. Three arms have ends pivoted on the base around the rotator, on which at least a magnet and a connecting portion are provided. Three springs have opposite ends urging the base and the arms respectively, and three connecting devices have opposite ends connected to the connecting portions of the arms and the rotator respectively, such that the arms are moved while the rotator is rotated.

### BACKGROUND OF THE INVENTION

1. Field of the Invention

The present invention relates generally to an exercise machine, and more particularly to a load controller of a magnetic brake for the exercise machine.

2. Description of the Related Art

Exercise machines, such as bike and air walker, usually have a brake to provide load for exercise. Typically, the brakes are classified into frictional type and magnetic type. The magnetic type brake provides magnets beside a flywheel that the flywheel is braked by the magnetic force of the magnets. The magnets are adjustable for a distance between the flywheel and the magnets to change the value of the magnetic force acted on the flywheel.

Chen's invention (U.S. Pat. No. 5,466,203) disclosed a magnetic brake, which provides a level with magnets thereon beside a flywheel. The level is moved to change the distance between the magnets and the flywheel. Wei et al., U.S. Pat. No. 5,848,953, taught a magnetic brake that magnets are mounted in a cavity of a flywheel. The magnets are drawn by a rope for movement along a diameter direction of the flywheel. Wei et al., U.S. Pat. No. 5,851,165, taught that the magnets are moved by a cam. The inventions, U.S. Pat. Nos. 5,879,273 and 6,234,938, taught that the magnets are moved toward or away from the flywheel.

The ranges of braking power output of above brakes are fixed after they are made. As we know, men usually have greater strength than women and children, and west people usually have greater strength than east people. The ranges of braking power output cannot meet all kinds of peoples' requirements.

### SUMMARY OF THE INVENTION

The primary objective of the present invention is to provide a load controller for an exercise machine, which the range of the load power output is adjustable by the designer or user.

According to the objective of the present invention, a load controller, which is mounted on a flywheel of an exercise machine, comprising a base mounted on the flywheel. A rotator is pivoted on the base for rotation, on which connecting portions are provided. Arms have ends pivoted on the base around the rotator, on which at least a magnet and a connecting portion are provided, and connecting devices have opposite ends connected to the connecting portions of the arms and the rotator respectively, such that the arms are moved while the rotator is rotated.

### BRIEF DESCRIPTION OF THE DRAWINGS

FIG. 1 is an exploded view of a first preferred embodiment of the present invention;

FIG. 2 is a front view of the first preferred embodiment of the present invention, showing the rotator not rotated;

FIG. 3 is a front view of the first preferred embodiment of the present invention, showing the rotator rotated;

FIG. 4 is a front view of a second preferred embodiment of the present invention, showing the rotator not rotated;

FIG. 5 is a front view of the second preferred embodiment of the present invention, showing the rotator rotated, and

FIG. 6 is a front view of a third preferred embodiment of the present invention.

### DETAILED DESCRIPTION OF THE INVENTION

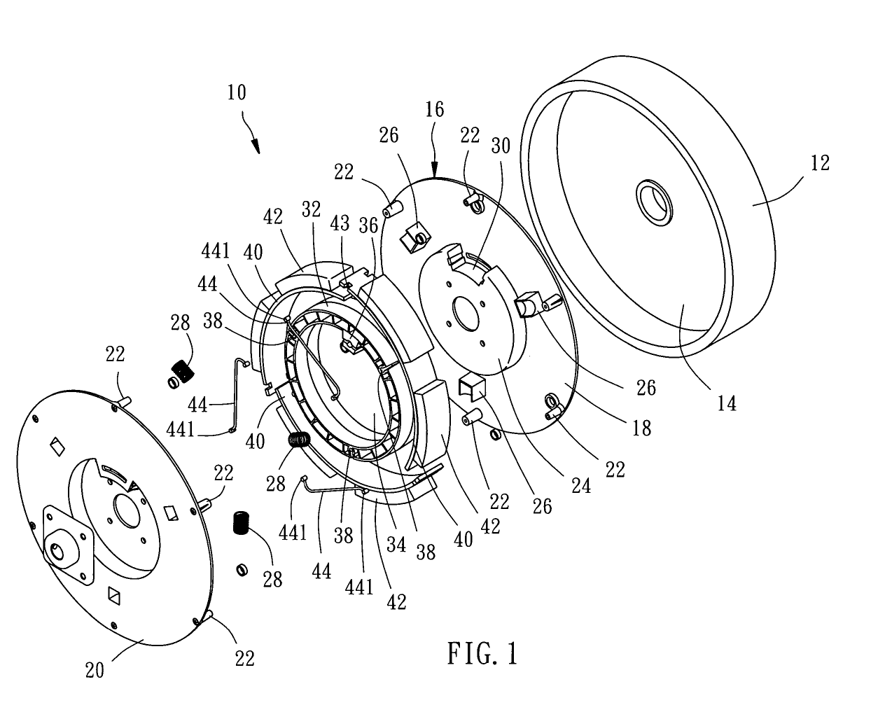

As shown in FIG. 1, a load controller 10 of the first preferred embodiment of the present invention, which is mounted in a cavity 14 of a flywheel 12, comprises:

A base 16 is consisted of two disks 18 and 20, each of which has posts 22 thereon for connection, such that a space is left between the disks 18 and 20. The disk 18 has a round protrusion 24 at a center of an interior side thereof and three spring bases 26 around the protrusion 24, in each of which a spring 28 is installed. The protrusion 24 has a gap 30 on a circumference thereof.

A rotator 32 has a hole 34 at a center thereof and a block 26 on a sidewall of the hole 34. The hole 34 of the rotator 32 is fitted to the protrusion 24 of the base 14, and the block 26 is received in the gap 30, such that the rotator is rotated in a predetermined angle. It is easy to understand that the gap may be on the rotator, and the block may be on the protrusion (not shown). The rotator 32 has three connecting portions 38 on the circumference, which are recesses in the present invention.

Three arms 40, on each of which two permanent magnets 42 are mounted respectively, have ends pivoted on the interior side of the disk 18 around the rotator 32. The springs 28 urge the arms 40 outwards respectively, such that the arms 40 rest on the posts 22 respectively. Each of the arms 40 has a connecting portion 43, which is a recess in the present invention, adjacent to a free end thereof.

Three connecting devices 44, each of which has ball joints 441 on opposite ends, have the joints 441 engaged with the connecting portions 38 and 43 of the rotator 32 and the arms 40 respectively, such that the arms 40 are moved by the rotation of the rotator 32. In the present invention, the connecting devices 44 are rigid bars, however, the connecting devices may be flexible members, such as metallic wires, ropes or chains.

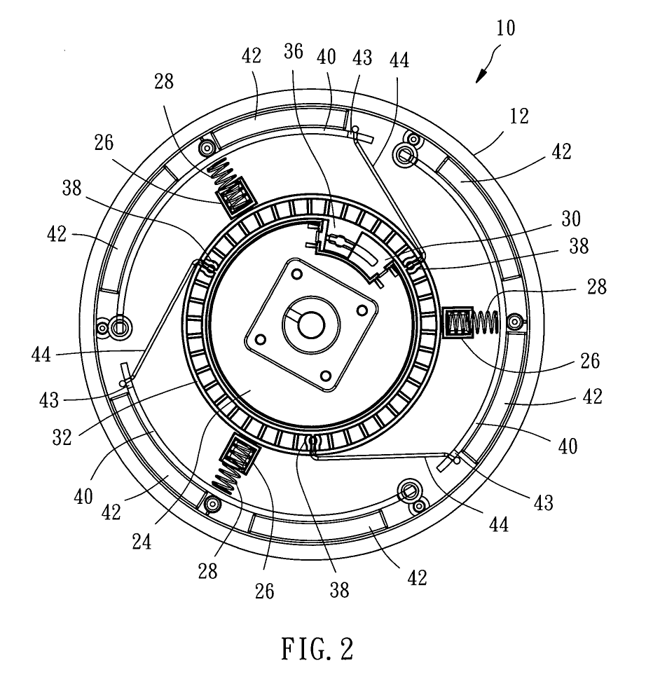

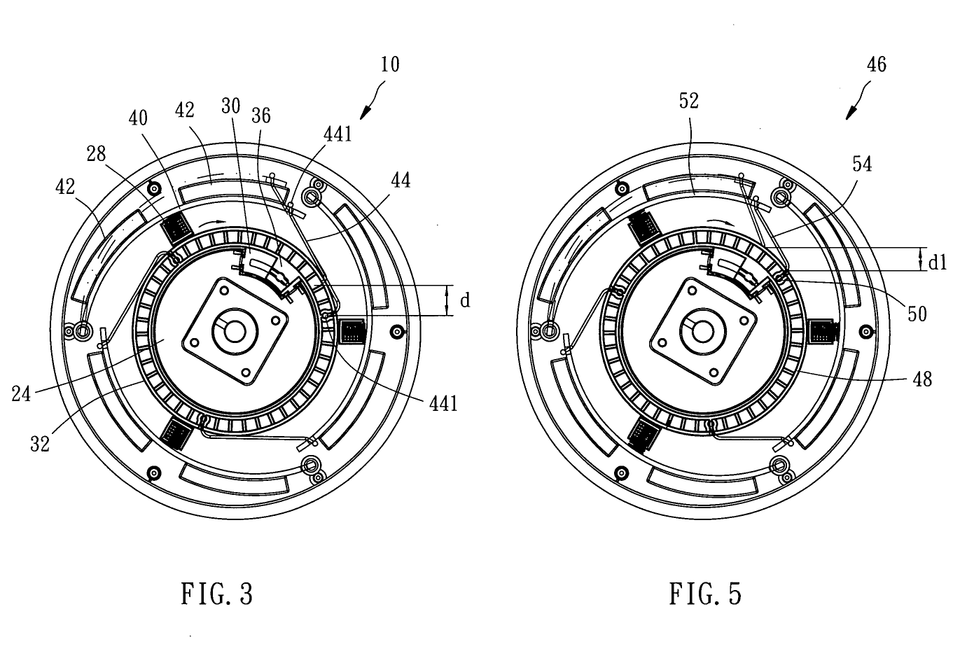

As shown in FIG. 2, at initial, the arms 40 rest on the posts 22, and the magnets 42 are closest to the flywheel 10 that the load controller 10 of the present invention has the greatest power to brake the flywheel 10. While the rotator 32 is rotated, as shown in FIG. 3, the arms 40 is moved inwards via the connecting devices 44. The braking power is gradually decreased because that a distance between the magnets 42 and the flywheel 10 is increased while the arms 40 are moved.

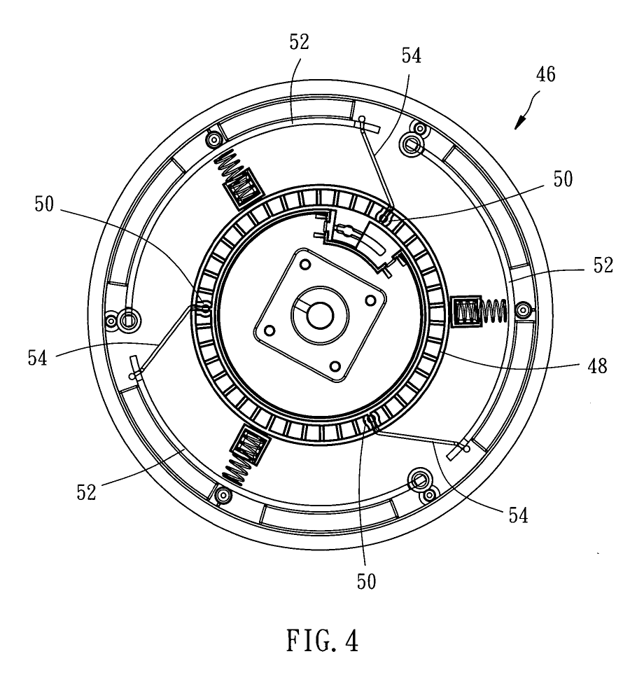

The reduction of the braking power of the load controller 10 of the present invention is directly relative to a vertical distance d of the movement of the connecting portion 38 of the rotator 32 rather than an angle of rotation of the rotator 32. In other words, under a condition of the rotator rotating for a predetermined angle, the arms are moved for different distances while the positions of the connecting portions are difference FIG. 4 and FIG. 5 show a load controller 46 of the second preferred embodiment of the present invention, which is similar to the load controller 10 of the first preferred embodiment of the present invention, except that a rotator 48 has connecting portions 50 closer to arms 52. Connecting devices 54 that connect the arms 52 and the connecting portions 50 of the rotator 48 are shorter than the connecting devices 44 of the first preferred embodiment. As shown in FIG. 3 and FIG. 5, while the rotator 48 of the load controller 46 of the second preferred embodiment rotates for an angle that is as same as that of the rotator 32 of the first preferred embodiment, a vertical distance d1 of the movement of the connecting portion 50 of the second preferred embodiment is less than the vertical distance d of the first preferred embodiment. That is, the load controller 10 of the first preferred embodiment has a greater braking power output range than that of the load controller 46 of the second preferred embodiment. In conclusion, the load controller of the present invention can change the pattern of the braking power output simply by changing the initial positions of the connecting portions of the rotator.

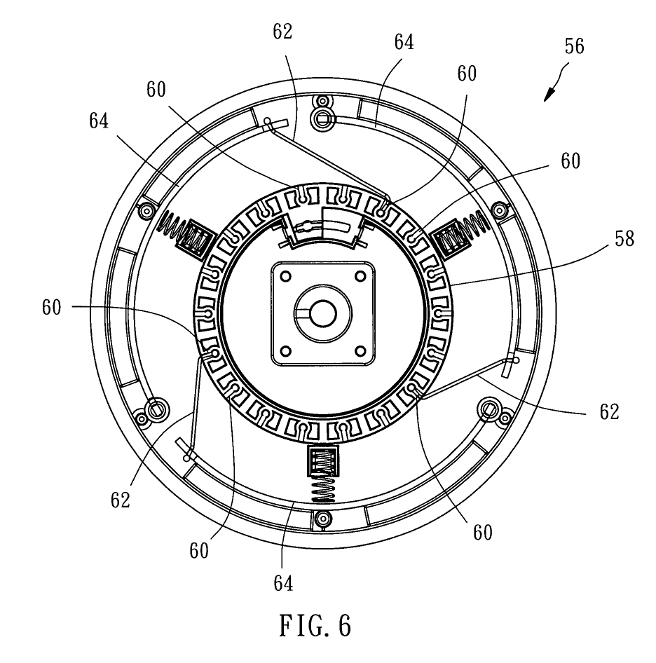

FIG. 6 shows a load controller 56 of the third preferred embodiment of the present invention, which is similar to the load controllers of above embodiments, having a rotator 58 with connecting portions 60 on a circumference thereof, three arms 64 with magnets thereon and three connecting devices 62 connecting the connecting portions 60 and the arms 64 respectively. A number of the connecting portions 60 of the rotator 58 is greater than a number of the arms 64. The connecting devices 62 are different in length to be connected to the corresponding connecting portions 60 of the rotator 58. As a result, the arms 62 are moved for difference distances while the rotator 58 is rotated for a predetermined angle, therefore, the total braking power output of the load controller 56 of the third preferred embodiment is different from that of the load controllers of above embodiments. Designer can adjust the range of braking power output simply by changing the connecting devices.

What is claimed is:

1. A load controller, which is mounted on a flywheel of an exercise machine, comprising:
a base;
a rotator pivoted on the base for rotation, on which a plurality of connecting portions are provided;
arms having ends pivoted on the base around the rotator, on which at least a magnet and a connecting portion are provided, and
connecting devices having opposite ends connected to the connecting portions of the arms and the rotator respectively, such that the arms are moved while the rotator is rotated.

2. The load controller as defined in claim 1, wherein the base has a protrusion, and the rotator has a hole to be fitted to the protrusion of the base.

3. The load controller as defined in claim 1, wherein the base is provided with a gap, and the rotator is provided with a block to be received in the gap, such that the rotator is rotated in a predetermined angle.

4. The load controller as defined in claim 2, wherein the base is provided with a gap on the protrusion, and the rotator is provided with a block on a sidewall of the hole to be received in the gap, such that the rotator is rotated in a predetermined angle.

5. The load controller as defined in claim 1, further comprising springs with opposite ends urging the base and the arms respectively.

6. The load controller as defined in claim 1, wherein the base has two disks, each of which a plurality of posts are provided for connection of the disks, and the base has a space between the disks, in which the rotator, the arms and the connecting devices are received.

7. The load controller as defined in claim 1, wherein the connecting devices are rigid bars, wires, ropes or chains.

8. The load controller as defined in claim 1, wherein the connecting devices have ball joints on the ends respectively, and the connecting portions of the rotator and the arms are recesses to received the ball joints of the connecting device therein.

9. A magnetic brake of an exercise machine, comprising:
a flywheel having a cavity;
a base mounted in the cavity of the flywheel;
a rotator pivoted on the base for rotation, on which a plurality of connecting portions are provided;
arms having ends pivoted on the base around the rotator, on which at least a magnet and a connecting portion are provided, and
connecting devices having opposite ends connected to the connecting portions of the arms and the rotator respectively, such that the arms are moved while the rotator is rotated;
wherein a number of the connecting portions of the rotator is greater than a number of the arms, such that the connecting devices may be connected to different.

10. The magnetic brake as defined in claim 9, where the connecting devices have different lengths.
